(19) United States
(12) Patent Application Publication
(10) Pub. No.: US 2006/0007341 A1
(43) Pub. Date: Jan. 12, 2006

(54) Image capturing apparatus

(75) Inventors: Kenji Nakamura, Takatsuki-shi (JP); Masahiro Kitamura, Osaka-shi (JP); Shinichi Fujii, Osaka-shi (JP); Yasuhiro Kingetsu, Sakai-shi (JP); Dai Shintani, Izumi-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/055,136

(22) Filed: Feb. 10, 2005

(30) Foreign Application Priority Data
Jul. 9, 2004 (JP) JP2004-203059

(51) Int. Cl. H04N 5/228; H04N 5/222

(52) U.S. Cl. 348/333.05

(57) ABSTRACT

The image capturing apparatus can perform an image capturing operation at a frame rate which is three times as high as a frame rate for displaying a moving image. At the time of moving image capturing, an operation of capturing three kinds of frame images is repeated while changing a focus condition in three levels of, for example, a focus backward of an infocus position on a main subject, a focus in the infocus position, and a focus forward of the infocus position. With this operation, a moving image constructed by images in which focus is achieved on a backward car, a moving image constructed by images in which focus is achieved on a car in the center, and a moving image constructed by images in which focus is achieved on a forward car can be recorded. As a result, moving images with three kinds of different image capturing conditions can be easily captured by a single image capturing operation.

This application is based on application No. 2004-203059 filed in Japan, the contents of which are hereby incorporated by reference.

### BACKGROUND OF THE INVENTION

1. Field of the Invention

The present invention relates to an image capturing apparatus for sequentially generating frame images of a subject.

Some image capturing apparatuses can capture a moving image and play it back.

2. Description of the Background Art

However, in capture of a moving image of the image capturing apparatus, situations of light around a subject and the position of the subject usually change momentarily. Even when a user captures the moving image once with predetermined conditions, whether the resultant image is played back as a predetermined result or not cannot be known until it is actually played back. Upon playback, the user knows for the first time that an unsatisfactory result is obtained.

### SUMMARY OF THE INVENTION

The present invention is directed to an image capturing apparatus.

According to the present invention, the image capturing apparatus comprises: (a) an image capturing device which sequentially generates frame images of a subject; (b) a driver which drives the image capturing device at a frame rate that is N times (N: integer of 2 or more) as high as a display frame rate used at the time of displaying a moving image on the display device; and (c) a controller which sequentially captures the frame images at the frame rate of N times while changing an image capturing condition in M levels (M: integer satisfying a relation of 2≦M≦N) each time the image capturing device is driven by the driver. Consequently, a plurality of moving images can be easily captured with different image capturing conditions by a single image capturing operation.

According to a preferred embodiment of the present invention, in the image capturing apparatus, the controller includes: (c-1) a giving controller which gives identification information for identifying each of levels of the image capturing condition to the frame images. Therefore, images captured with different image capturing conditions can be easily classified.

The present invention is also directed to an image playback apparatus for playing back image data.

It is therefore an object of the present invention to provide a technique of an image capturing apparatus capable of easily capturing a plurality of moving images with different image capturing conditions by a single image capturing operation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an image capturing apparatus according to a first preferred embodiment of the present invention;

FIG. 2 is a rear view of the image capturing apparatus;

FIG. 3 is a diagram showing functional blocks of the image capturing apparatus;

FIGS. 4A to 4D are diagrams illustrating a moving image capturing operation and a playback operation of the image capturing apparatus;

FIGS. 5A to 5C are diagrams illustrating three kinds of focus states;

FIG. 6 is a flowchart for describing the moving image capturing operation of the image capturing apparatus;

FIG. 7 is a diagram illustrating a frame image captured by the moving image capturing operation;

FIG. 8 is a diagram showing a data sequence of a frame image recorded on a memory card;

FIG. 9 is a flowchart for describing the moving image playback operation of the image capturing apparatus;

FIG. 10 is a diagram showing a selection screen for selecting a moving image file to be played back;

FIG. 11 is a diagram showing a selection screen for selecting a series to be played back;

FIG. 12 is a diagram illustrating the playback operation;

FIGS. 13A to 13C are diagrams illustrating three kinds of exposure states of an image capturing apparatus according to a second preferred embodiment of the present invention;

FIG. 14 is a flowchart for describing the moving image capturing operation of the image capturing apparatus;

FIG. 15 is a diagram illustrating frame images captured by the moving image capturing operation;

FIGS. 16A to 16C are diagrams illustrating three kinds of zoom states of an image capturing apparatus according to a third preferred embodiment of the present invention;

FIG. 17 is a flowchart for describing the moving image capturing operation of the image capturing apparatus;

FIG. 18 is a diagram illustrating frame images captured by the moving image capturing operation;

FIGS. 19A to 19C are diagram illustrating three kinds of white balance states of an image capturing apparatus according to a fourth preferred embodiment of the present invention;

FIG. 20 is a flowchart for describing the moving image capturing operation of the image capturing apparatus; and

FIG. 21 is a diagram illustrating frame images captured by the moving image capturing operation.

### DESCRIPTION OF THE PREFERRED EMBODIMENTS

### First Preferred Embodiment

Configuration of main part of image capturing apparatus

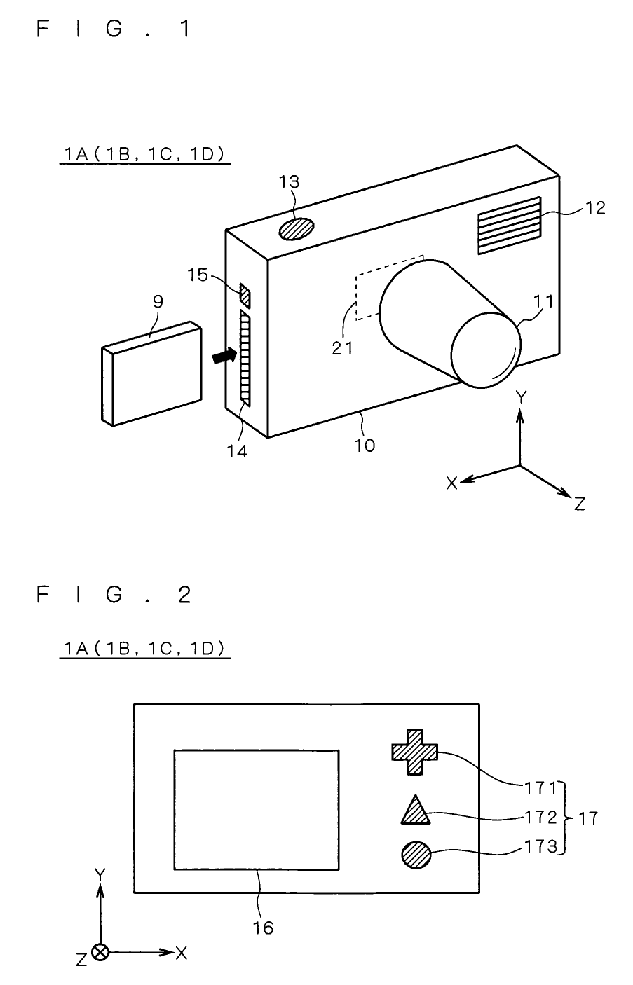

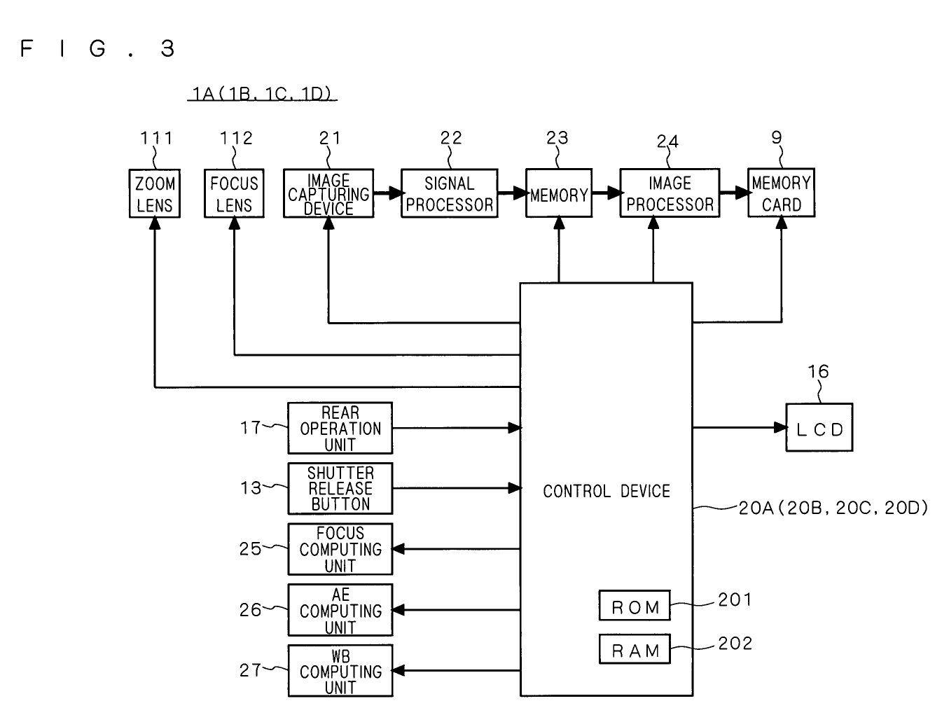

FIG. 1 is a perspective view showing an image capturing apparatus 1A according to a first preferred embodiment of the present invention. FIG. 2 is a rear view of the image capturing apparatus 1A. In FIGS. 1 and 2, three axes of X, Y and Z which are orthogonal to one another are shown to clarify the directional relations.

The image capturing apparatus 1A takes the form of, for example, a digital camera. In the front face of a camera body 10, a taking lens 11 and an electronic flash 12 are provided. An image capturing device 21 for photoelectrically converting a subject image entering via the taking lens 11 to generate a color image signal is provided behind the taking lens 11. In this preferred embodiment, an image capturing device of a C-MOS type is used as the image capturing device 21.

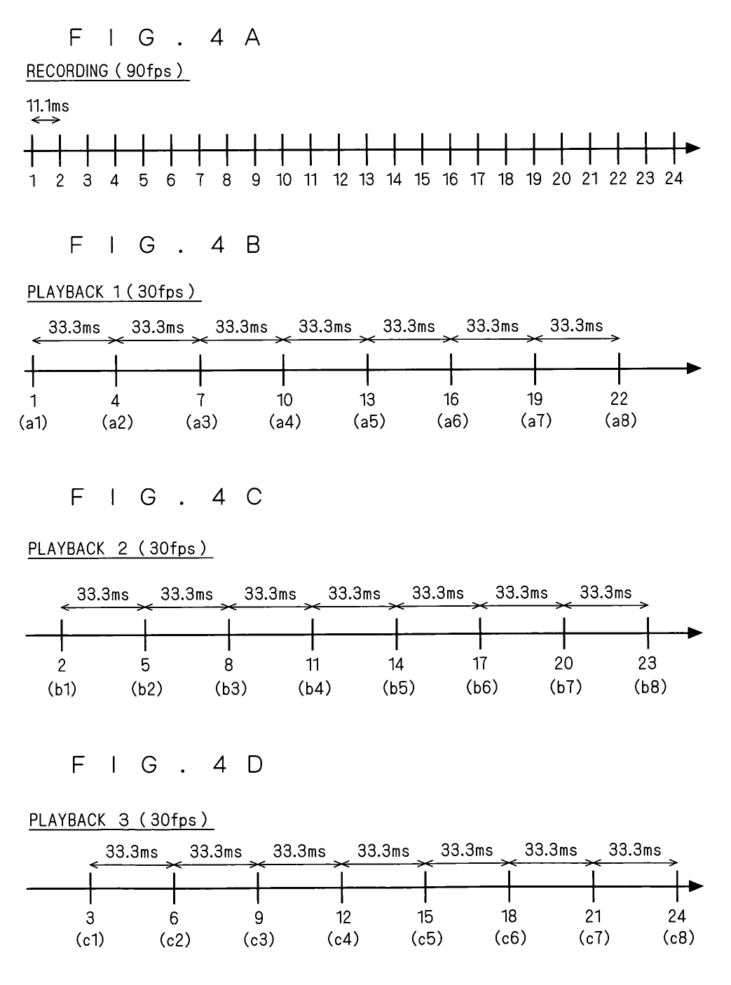

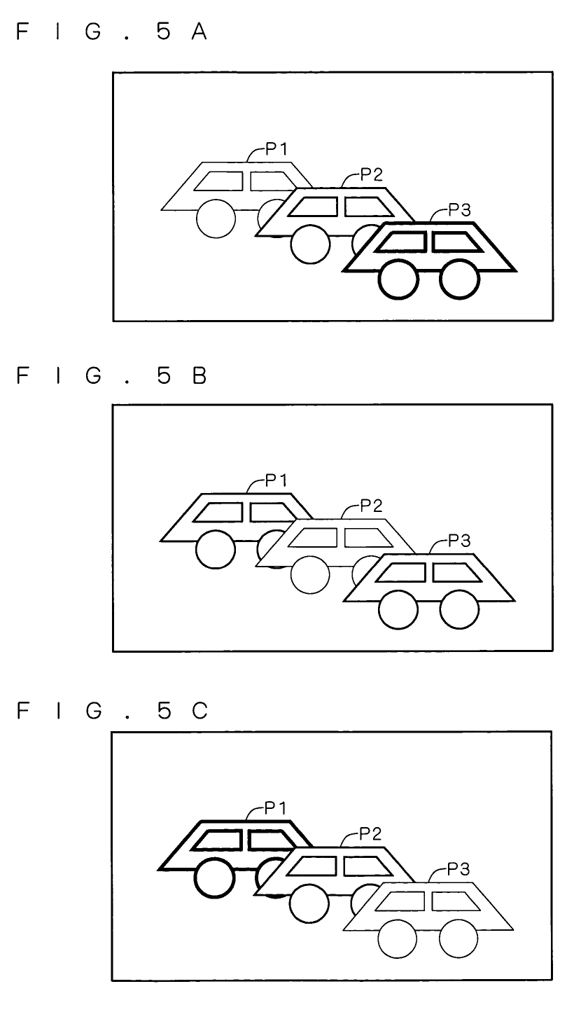

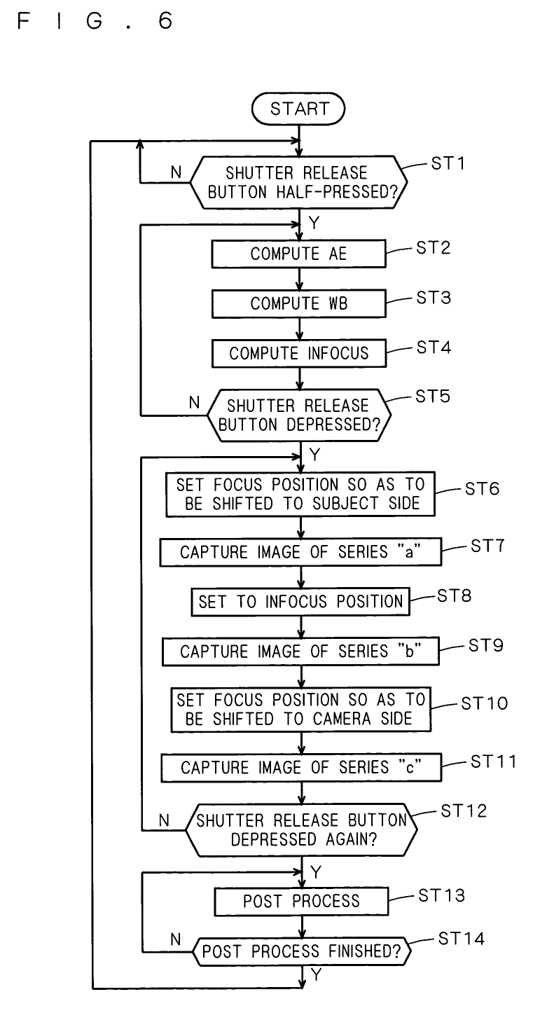

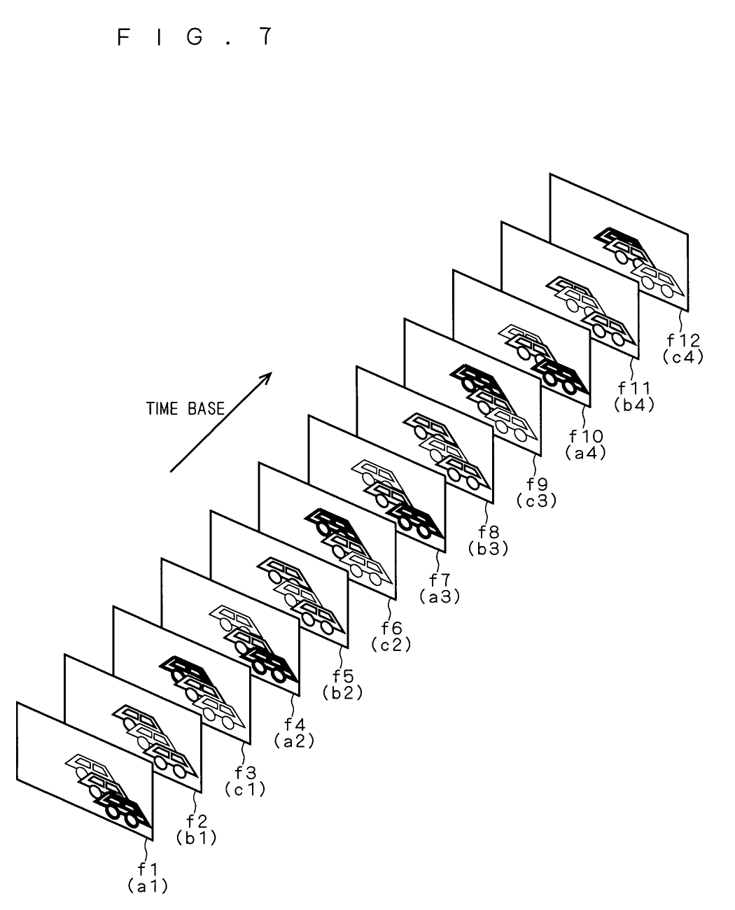

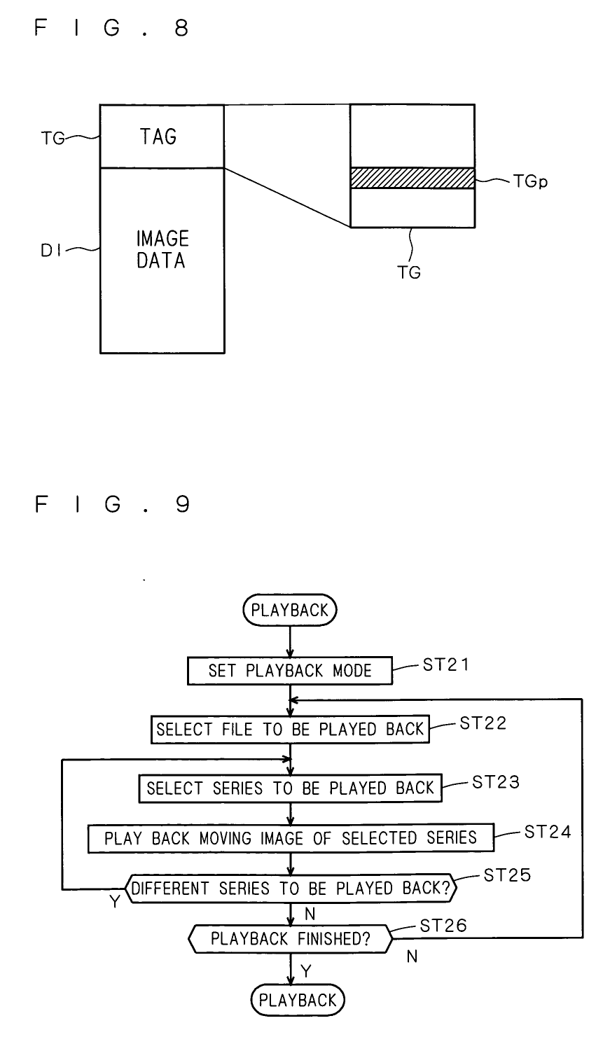

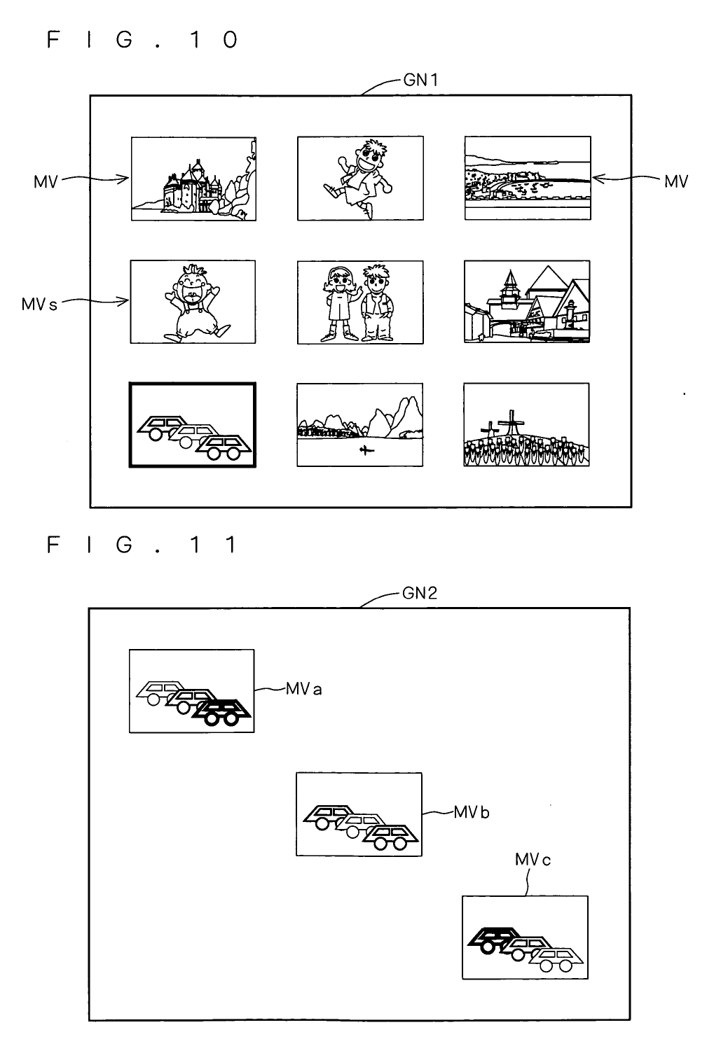

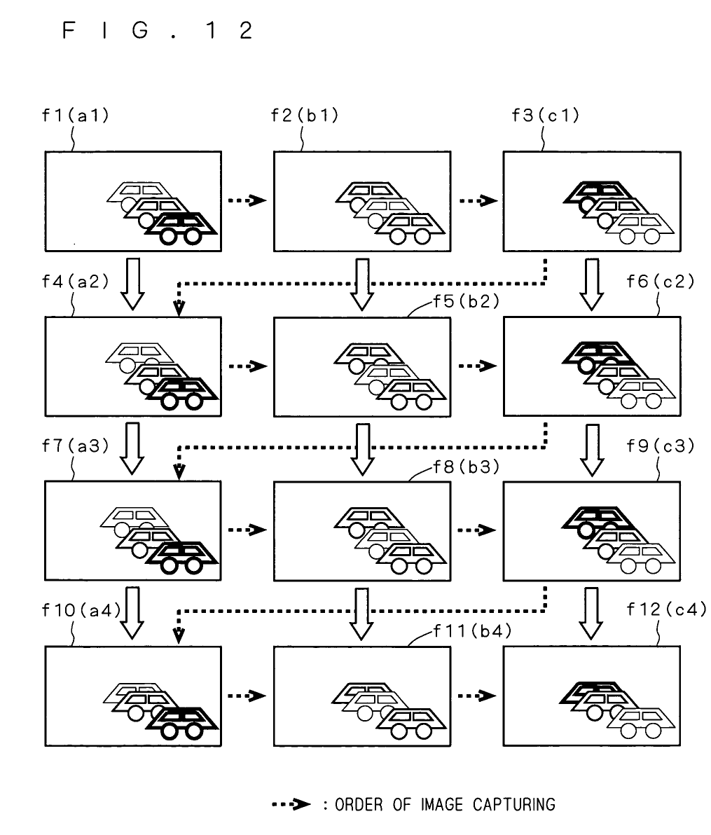

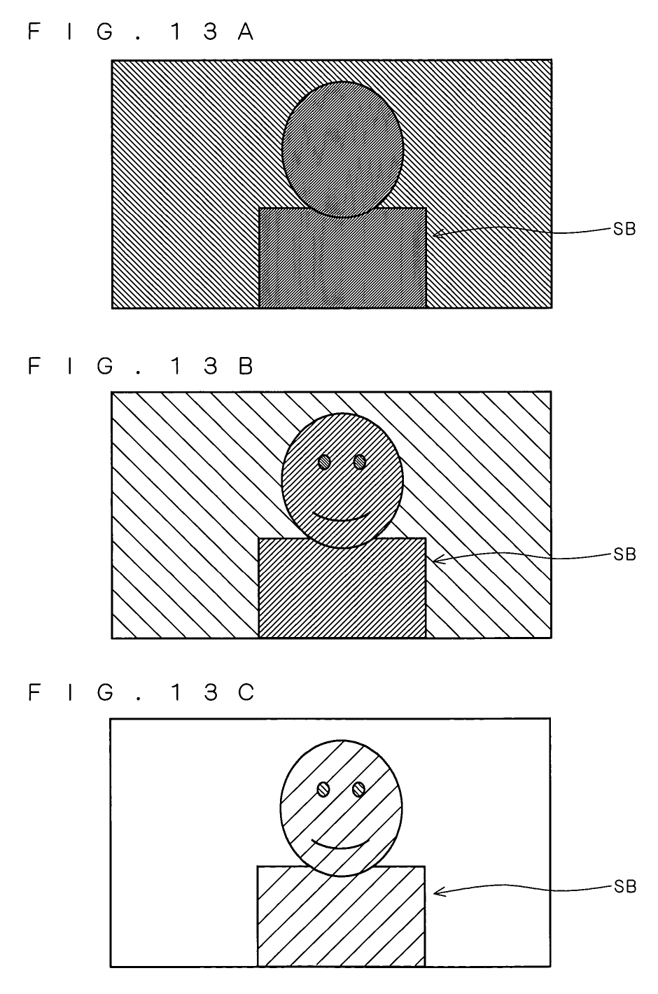

The taking lens 11 includes a zoom lens 111 and a focus lens 112 (see FIG. 3). By driving the lenses in the optical axis direction, zooming or focusing of a subject image formed on the image capturing device 21 can be realized.

On the top face of the image capturing apparatus 1A, a shutter release button 13 is disposed. The shutter release button 13 gives an image capturing instruction to the image capturing apparatus 1A when the user depresses the shutter release button 13 to capture an image of a subject. The shutter release button 13 is constructed as a two-level switch capable of detecting a half-pressed state (S1 state) and a depressed state (S2 state). When the depressed state (S2 state) is set in a state where the moving image capturing is set as an image capturing mode, the moving image capturing is performed for a period until the depressed state is set again.

In a side face of the image capturing apparatus 1A, a card slot 14 in which a memory card 9 for recording image data captured by the image capturing operation accompanying the operation of depressing the shutter release button 13 is to be inserted is formed. Further, a card eject button 15 that is operated to eject the memory card 9 from the card slot 14 is also disposed in the side face of the image capturing apparatus 1A.

In the rear face of the image capturing apparatus 1A, a liquid crystal display (LCD) 16 for performing live view display such that a moving image of a subject is displayed before the image capturing or displaying a captured image or the like, and a rear operation unit 17 for changing various setting states of the image capturing apparatus 1A such as shutter speed and zooming are provided.

The rear operation unit 17 is constructed by a plurality of operation buttons 171 to 173 and can perform zooming operation, exposure setting and the like by operating, for example, the operation button 171. By operating the operation button 173, a moving image capturing mode and a playback mode can be set.

FIG. 3 is a diagram showing functional blocks of the image capturing apparatus 1A. In the following, functions of the parts will be described according to the sequence of moving image capturing. In this preferred embodiment, the motion JPEG format is used as the moving image format.

When a main switch is operated and a camera is started, a subject optical image is formed on the image capturing device 21 through the zoom lens 111 and the focus lens 112, and frame images of analog signals of the subject are sequentially generated. The analog signal is converted to a digital signal by A/D conversion of a signal processor 22 and the digital signal is temporarily stored in a memory 23.

The image data temporarily stored in the memory 23 is subjected to image processing such as γ conversion and aperture control in an image processor 24 and, then, is subjected to processing so as to be displayed on the LCD 16, and a resultant image is displayed as a live view on the LCD 16.

Since a live view of the subject is displayed in such a manner, the user can check the composition and change the angle of view by operating the operation button 171 while visually recognizing an image of the subject. In this case, when the zooming operation performed by the operation button 171 is detected by a control device 20A, the zoom lens 111 is driven to set the angle of view desired by the user. Although the image capturing device 21 in the image capturing apparatus 1A can perform image capturing at 90 fps (frame per second) as will be described later, at the time of displaying a live view, an image is updated once per three frames on the LCD 16.

When the control device 20A detects the half-pressed state (S1) of the shutter release button 13, on the basis of an output from the image capturing device 21, an AE computing unit 26 calculates a proper exposure amount for an entire captured image and sets shutter speed and a gain of an amplifier in the signal processor 22.

When computation in the AE computing unit 26 is finished, a proper white balance (WB) set value is calculated by a WB computing unit 27 and an R gain and a G gain for correcting white balance are set by the image processor 24.

After completion of computation in the WB computing unit 27, a focus computing unit 25 computes an AF evaluation value for use in AF of a contrast method on the basis of an output from the image capturing device 21. Based on the result of computation, the control device 20A controls the driving of the focus lens 112 to achieve focus on a subject. Concretely, a focus motor (not shown) is driven, a lens position at which a high frequency component of an image captured by the image capturing device 21 becomes the peak is detected, and the focus lens 112 is moved to the position.

When the shutter release button 13 is fully depressed, moving image capturing starts. During the moving image capturing, image data from the image processor 24 is stored in the memory card 9. When the shutter release button 13 is depressed again, the moving image capturing is finished. The live view display is continuously performed.

The sequence of moving image capturing of the image capturing apparatus 1A described above is executed when the control device 20A controls the respective components in a centralized manner.

The control device 20A has a CPU and, also, has a ROM 201 and a RAM 202. In the ROM 201, various control programs for controlling the image capturing apparatus 1A are stored.

The moving image capturing operation and the playback operation of the image capturing apparatus 1A will be described below in detail.

Moving Image Capturing Operation and Playback Operation

FIGS. 4A to 4D are diagrams illustrating the moving image capturing operation and the playback operation of the image capturing apparatus 1A. In each of FIGS. 4A to 4D, the horizontal axis indicates the time base.

In the image capturing device 21 of the image capturing apparatus 1A, as shown in FIG. 4A, the moving image capturing can be performed at 90 fps, that is, the time interval between frames of about 11.1 ms. Specifically, the image capturing device 21 can be driven at a frame rate which is three times as high as the display frame rate (30 fps) used at the time of displaying a moving image on the LCD 16. Numerals 1, 2, 3, . . . in FIG. 4A indicate frame numbers. The larger the number is, the latter the image is captured.

If a moving image recorded at a frame rate is played back at a general frame rate of 30 fps (the time interval between frames of about 33.3 ms), the moving image can be sufficiently regarded as a moving image when seen by human eyes. The image capturing apparatus 1A consequently reduces frame images recorded at 90 fps to ⅓ and plays back the reduced images.

Concretely, as shown in FIG. 4B, images of frame numbers 1, 4, 7, . . . , that is, 3n−2 (n: natural number) are extracted from a group of frames (Nos. 1 to 24) shown in FIG. 4A, and are played back as a moving image. In the following, for convenience of description, images of frame numbers 1, 4, 7, . . . will be called a group of images of a series “a” and will be also indicated as a1, a2, a3, . . . .

As shown in FIG. 4C, images of frame numbers 2, 5, 8, . . . , that is, 3n−1 (n: natural number) are extracted from the group of frames (Nos. 1 to 24) shown in FIG. 4A, and are played back as a moving image. In the following, for convenience of description, images of frame numbers of 2, 5, 8, . . . will be called a group of images of a series “b” and will be also displayed as b1, b2, b3, . . . .

As shown in FIG. 4D, images of frame numbers of 3, 6, 9, . . . , that is, 3n (n: natural number) are extracted from the group of frames (Nos. 1 to 24) shown in FIG. 4A, and are played back as a moving image. In the following, for convenience of description, images of frame numbers of 3, 6, 9, . . . will be called a group of images of a series “c” and will be also indicated as c1, c2, c3, . . . .

As described above, the image capturing apparatus 1A can simultaneously obtain the image groups of the series “a” to “c” by a single image capturing operation. By performing image capturing on the series of “a” to “c” with different image capturing conditions, three kinds of moving images can be obtained. For example, by capturing the image groups of the series “a” to “c” while changing the taking lens in three positions of a position where focus is achieved on a main subject (in this case, a center portion of a picture), a position where focus is achieved slightly forward of the subject, and a position where focus is achieved slightly backward of the subject, moving images in three kinds of focus states can be obtained. Concretely, while changing the image capturing condition based on a change pattern of sequentially changing the focus condition to the three focus positions in order each time the image capturing device 21 is driven, frame images are sequentially obtained at a frame rate of 90 fps.

FIGS. 5A to 5C are diagrams illustrating the three kinds of focus states. Each of FIGS. 5A to 5C shows a scene in which three cars P1 to P3 travel. The distance from the image capturing apparatus 1A increases in order from the car P3 to the car P1.

The image shown in FIG. 5A is an image captured by performing the infocus computation on the car P2 as the main subject (focused subject) by the focus computing unit 25 and setting the focus position to a position a little rearward of the infocus position, so that focus is achieved on the car P1. By image capturing based on the image capturing control parameter obtained by shifting a reference parameter corresponding to the infocus position which is set by infocus computation (predetermined process) backward only by a predetermined amount, focus is achieved on the car P1. In FIGS. 5A to 5C, it is expressed that the wider the line of the cars P1 to P3 is, the more the image is out of focus.

The image shown in FIG. 5B is an image captured in the infocus position after infocus computation on the car P2 as a main subject is executed by the focus computing unit 25, and focus is achieved on the car P1 in the center of the screen.

The image shown in FIG. 5C is an image captured by performing infocus computation on the car P2 as the main subject by the focus computing unit 25 and, after that, setting a focus position slightly forward of the infocus position, so that focus is achieved on the car P3. By image capturing based on the image capturing control parameter obtained by shifting the reference parameter corresponding to the infocus position that is set by the infocus computation (predetermined process) forward only by a predetermined amount, focus is achieved on the car P3.

As described above, the image capturing apparatus 1A can perform image capturing in three kinds of focus states, so that the user can concentrate on image capturing without minding whether or not focus is accurately achieved on a car to be recorded in a focus state at the time of moving image capturing.

A concrete moving image capturing operation for capturing moving images in the three kinds of focus states will now be described.

FIG. 6 is a flowchart for describing moving image capturing operation in the image capturing apparatus 1A. The operation is executed by the control device 20A.

First, the moving image capturing mode is set by operation on the operation button 173 and whether the shutter release button 13 is half-pressed by the user or not in a state where a preview is displayed on the LCD is determined (step ST1). When the shutter release button 13 is half-pressed, the program advances to step ST2. If not, step ST1 is repeated.

In step ST2, AE computation is performed by the AE computing unit 26 to determine proper shutter speed of the image capturing device 21 and the gain of the signal processor 22.

In step ST3, WB computation is executed by the WB computing unit 27 to determine proper R and B gains.

In step ST4, infocus computation is executed by the focus computing unit 25 to move the focus lens 112 to the infocus position of the main subject by the AF of the contrast method.

In step ST5, whether the shutter release button 13 is depressed by the user or not is determined. In the case where the shutter release button 13 is depressed, the program advances to step ST6. If not, the program returns to step ST2.

In step ST6, the focus position of the focus lens 112 is set to the backward side. Concretely, the focus lens 112 is moved from the infocus position on the main subject detected in step ST4 to the backward side.

In step ST7, an image in the series “a” as shown in FIG. 5A is captured in the focus state which is set in step ST6. The image captured by the image capturing device 21 is processed by the signal processor 22 and is temporarily stored in the memory 23. After that, the image is subjected to the image processing in the image processor 24, and the processed image is recorded on the memory card 9.

In step ST8, the focus lens 112 is set in the infocus position. Concretely, the focus lens 112 is moved to the infocus position of the main subject detected in step ST4.

In step ST9, an image of the series “b” as shown in FIG. 5B is captured in the state where focus is achieved on the main subject. The image captured by the image capturing device 21 is processed by the signal processor 22 and the processed image is temporarily stored in the memory 23. After that, the image is subjected to the image processing in the image processor 24 and the processed image is recorded in the memory card 9.

In step ST10, the focus position of the focus lens 112 is set to the forward side. Concretely, the focus lens 112 is moved from the infocus position on the main subject detected in step ST4 into a direction corresponding to the forward side of the infocus position.

In step ST11, an image in the series “c” as shown in FIG. 5C is captured in the focus state which is set in step ST10. The image captured by the image capturing device 21 is processed by the signal processor 22 and is temporarily stored in the memory 23. After that, the image is subjected to the image processing in the image processor 24, and the processed image is recorded on the memory card 9.

In step ST12, whether the shutter release button 13 is depressed again or not is determined. In the case where the shutter release button 13 is depressed, the program advances to step ST13. If not, the program returns to step ST6 and repeats the image capturing operation.

In step ST13, a post process is performed. Concretely, image processing is performed on images still remaining on the memory 23 by the operations in steps ST7, ST9 and ST11, a tag is generated as will be described later, and an operation of recording the resultant onto the memory card 9 is performed.

In step ST14, whether the post process is finished or not is determined. In the case where the post process is finished, the program returns to step ST1. In the case where the post process is not finished, the program repeats step ST13.

By the moving image capturing operation as described above, images of frames shown in FIG. 7 can be captured. Specifically, images of the series “a” of frames f1(a1), f4(a2), f7(a3) and f10(a4) are sequentially captured by the operation in step ST7, images in the series “b” of frames f2(b1), f5(b2), f8(b3) and f11(b4) are sequentially captured by the operation in step ST9, and images in the series “c” of frames f3(c1), f6(c2), f9(c3) and f12(c4) are sequentially captured by the operation in step ST11.

In steps ST6 and ST10, it is not indispensable to set the focus position so as to be shifted to the forward or backward from the infocus position of the main subject only by a predetermined amount. For example, focus may be achieved by performing infocus computation on each of the cars P1 and P3 shown in each of FIGS. 5A to 5C each time the image capturing is performed. In this case, infocus precision on a target other than the main subject improves.

Playback of a moving image captured in such a manner will be described below.

FIG. 8 is a diagram showing a data sequence of a frame image recorded on the memory card 9.

Image data DI of each recorded frame is added with tag information TG indicative of the image capturing condition and the like. In a part TGp of the tag information TG, an image capture condition tag indicative of the image capture condition with which the image data DI is captured, that is, the focus state in which the image data DI is captured is provided.

By giving identification information for discriminating a stage in the image capture condition to a frame image, the user can judge that the recorded image data corresponds to an image of the series “a”, “b” or “c”. Specifically, frame images to each of which the image capture condition tag (identification information) is given are sequentially recorded on the memory card (recording medium) 9. After that, frame images having common information of the image capture condition tag are extracted from the plurality of frame images recorded on the memory card 9 and the extracted frame images are sequentially displayed on the LCD 16 at a frame rate for display. In such a manner, moving images can be easily played back by image capture condition.

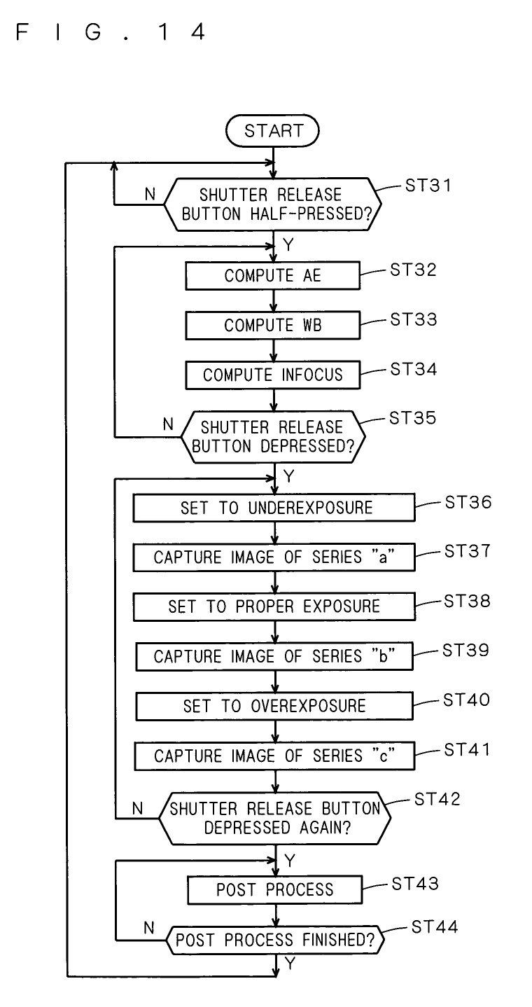

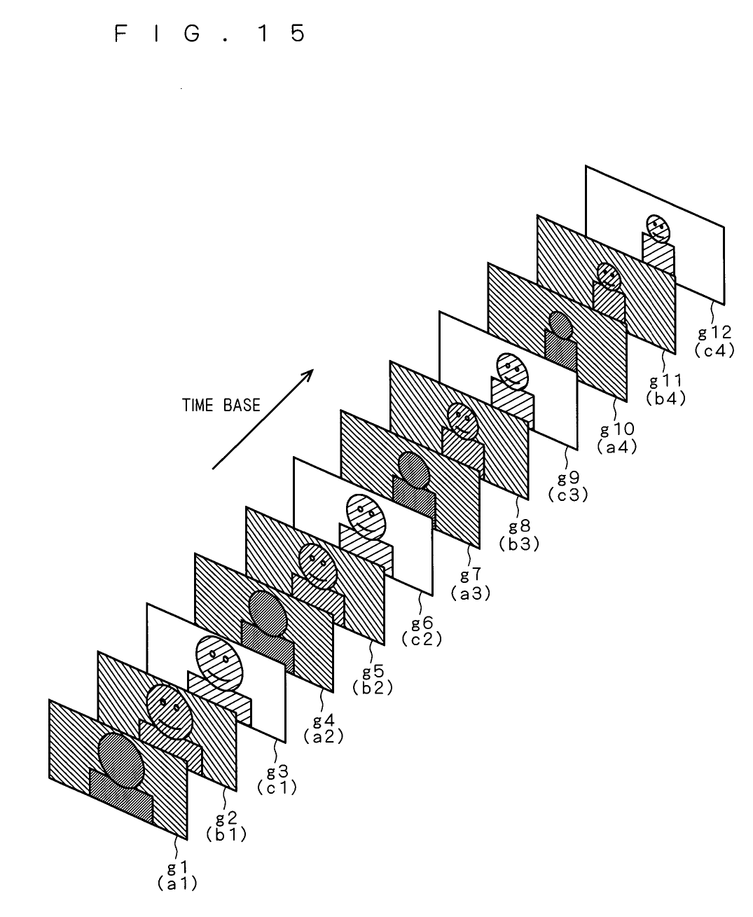

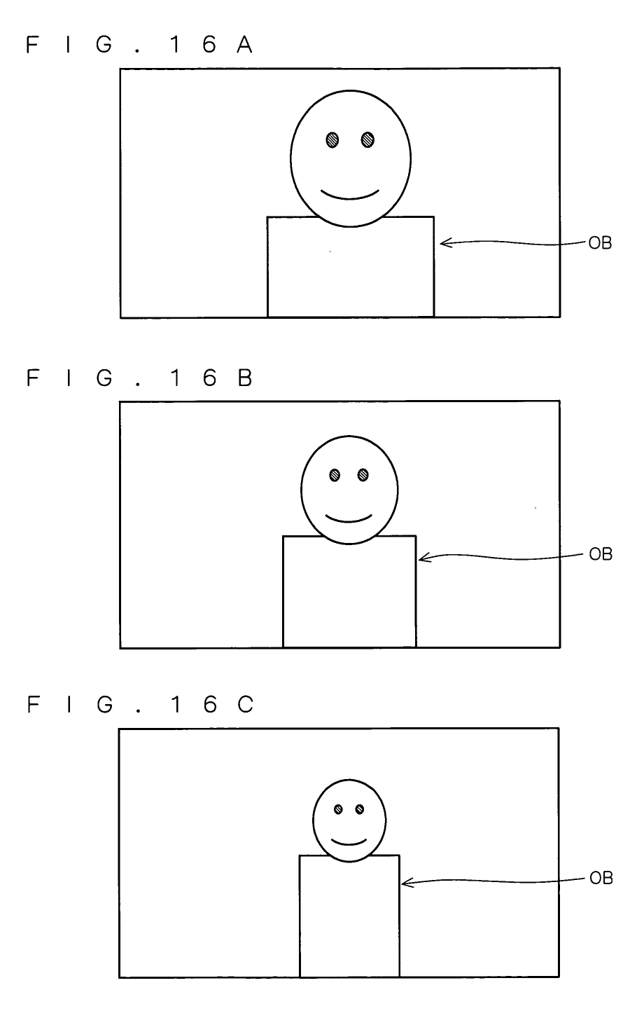

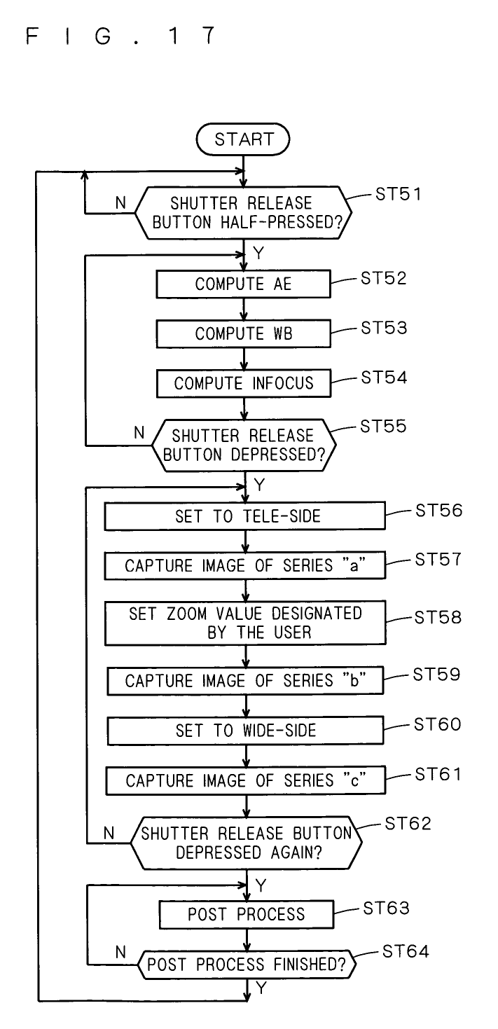

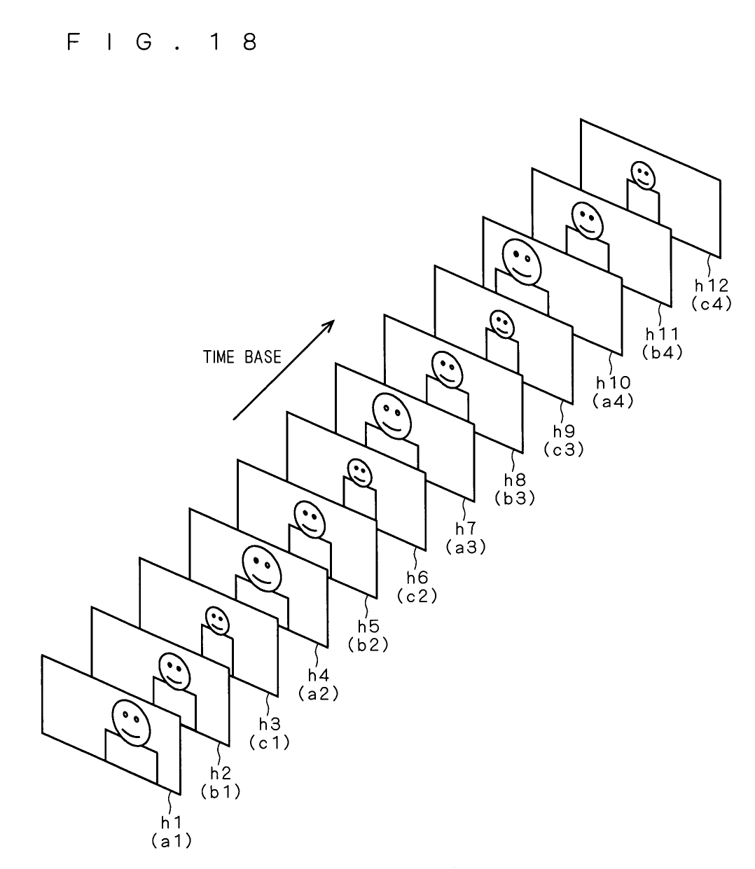

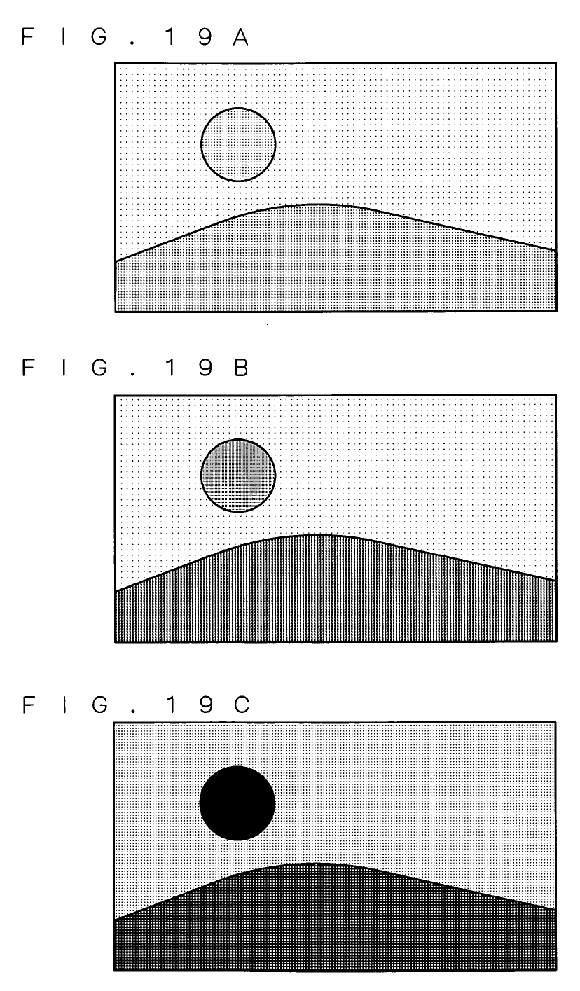

FIG. 9 is a flowchart for describing a moving image payback operation in the image capturing apparatus 1A. The playback operation is executed by the control device 20A.

In step ST21, in response to an operation of the user on the operation button 173, the image capturing apparatus 1A is set in a playback mode of playing back a moving image captured in a moving image capturing mode.

In step ST22, a moving image file to be played back is selected. Concretely, a selection screen GN1 (FIG. 10) displaying a plurality of frame images MV indicative of contents of the moving image files is displayed on the LCD 16. The user operates the operation button 171 to designate one moving image file.

On assumption that a moving image file corresponding to a frame image MVs in a lower left position of the selection screen GN1 is selected by the user in step ST22, the following description will be given.

In step ST23, a series to be played back is selected. Concretely, a selection screen GN2 (FIG. 11) displaying a frame image MVa of the series “a” captured with the focus position on the backward side, a frame image MVb of the series “b” captured in an infocus state, and a frame image MVc captured with the focus position on the forward side is displayed on the LCD 16. The user operates the operation button 171 to thereby designate a file of a desired series.

In step ST24, a moving image of the series selected in step ST23 is played back. In the following, the playback operation will be concretely described.

FIG. 12 is a diagram illustrating the playback operation. Frame images f1 to f12 in the diagram correspond to frame images f1 to f12 at the time of moving image capturing shown in FIG. 7.

In the case where the series “a” is selected by the user, based on information of the image capturing condition tag TGp shown in FIG. 8, frame images f1(a1), f4(a2), f7(a3) and f10(a4) are extracted from all of the frame images recorded, and are sequentially played back and displayed on the LCD 16.

In the case where the series “b” is selected by the user, based on information of the image capturing condition tag TGp shown in FIG. 8, frame images f2(b1), f5(b2), f8(b3) and f11(b4) are extracted from all of the frame images recorded, and are sequentially played back and displayed on the LCD 16.

Similarly, in the case where the series “c” is selected by the user, based on information of the image capturing condition tag TGp shown in FIG. 8, frame images f3(c1), f6(c2), f9(c3) and f12(c4) are extracted from all of the frame images recorded, and are sequentially played back and displayed on the LCD 16.

Referring again to FIG. 9, description will be continued.

In step ST25, whether the user plays back a different series or not is determined. For example, after completion of the playback operation in step S24, the selection screen GN2 shown in FIG. 12 is displayed on the LCD 16 and whether operation of finishing the selection screen GN2 is performed by the user or not is determined. In the case of playing back a different series, the program returns to step ST23. If not, the program advances to step ST26.

In step ST26, whether the user finishes playback or not is determined. Concretely, whether the operation button 173 is operated by the user and whether the playback mode is canceled or not is determined. In the case where playback is not finished, the program returns to step ST22.

By the operation of the image capturing apparatus 1A, image capturing is performed while changing the focus state in three levels at a frame rate which is three times as high as the display frame rate. Consequently, three kinds of moving images can be easily captured by a single image capturing operation, and the variety of image capturing is widened. Even when the user feels unsatisfactory regarding a focus state which was determined proper before image capture, since other moving images of different focus states were also captured, recording of a moving image satisfactory for the user can be expected.

### Second Preferred Embodiment

An image capturing apparatus 1B according to a second preferred embodiment of the present invention has a configuration similar to that of the first preferred embodiment shown in FIGS. 1 to 3 except for the configuration of the control device.

In a control device 20B of the image capturing apparatus 1B, a control program for performing moving image capturing operation to be described below is stored in the ROM 201.

Moving Image Capturing Operation

In a manner similar to the image capturing apparatus 1A of the first preferred embodiment, the image capturing apparatus 1B can perform moving image capturing at 90 fps shown in FIG. 4A and can capture moving images of three kinds of the series “a” to “c” by a single image capturing operation. In the image capturing apparatus 1B, the focus condition is not changed in three levels unlike the first preferred embodiment but an exposure condition is changed in three levels.

FIGS. 13A to 13C are diagrams illustrating three kinds of exposure states. In images shown in FIGS. 13A to 13C, a subject 5B is photographed with backlight.

An image shown in FIG. 13A is captured by performing AE computation by the AE computing unit 26 and, after that, setting to the underexposure side with respect to a proper exposure state on an entire image.

An image shown in FIG. 13B is captured by performing AE computation by the AE computing unit 26 and, after that, setting to the proper exposure state (reference parameter) on an entire image.

An image shown in FIG. 13B is captured by performing AE computation by the AE computing unit 26 and, after that, setting to the overexposure side with respect to the proper exposure state on an entire image. Since image capturing is performed with backlight, the exposure state of the subject SB in the image shown in FIG. 13C captured with overexposure is better than that in the image shown in FIG. 13B captured in the proper exposure state in the entire image.

As described above, image capturing can be performed in three kinds of exposure states in the image capturing apparatus 1B. Therefore, the user can concentrate on an image capturing operation without minding whether exposure on the subject SB is proper or not at the time of moving image capturing.

A concrete moving image capturing operation of capturing moving images in three kinds of exposure states as described above will now be described.

FIG. 14 is a flowchart for describing the moving image capturing operation in the image capturing apparatus 1B. The operation is executed by the control device 20B.

In steps ST31 to ST35, operations similar to those in steps ST1 to ST5 shown in the flowchart of FIG. 6 are performed.

In step ST36, underexposure is set. Concretely, the shutter speed of the image capturing device 21 and the gain of the signal processor 22 determined in step ST32 are changed to the underexposure side only by a predetermined amount.

In step ST37, an image of the series “a” as shown in FIG. 13A is captured in the underexposure state. An image captured by the image capturing device 21 is processed by the signal processor 22 and the processed image is temporarily stored in the memory 23. After that, the image is subjected to imaging process in the image processor 24, and the resultant image is recorded on the memory card 9.

In step ST38, exposure is set to be proper. Concretely, the shutter speed of the image capturing device 21 and the gain of the signal processor 22 determined in step ST32 are set.

In step ST39, an image of the series “b” as shown in FIG. 13B is captured in a state where exposure is proper.

In step ST40, overexposure is set. Concretely, the shutter speed of the image capturing device 21 and the gain of the signal processor 22 determined in step ST32 are changed to the overexposure side only by a predetermined amount.

In step ST41, an image of the series “c” as shown in FIG. 13C is captured in the overexposure state.

In steps ST42 to ST44, operations similar to those in steps ST12 to ST14 in the flowchart of FIG. 6 are performed.

By the moving image capturing operation as described above, each frame image shown in FIG. 15 can be captured. Specifically, images of the series “a” of frames g1(a1), g4(a2), g7(a3) and g10(a4) are sequentially captured by the operation in step ST37, images of the series “b” of frames g2(b1), g5(b2), g8(b3) and g11(b4) are sequentially captured by the operation in step ST39, and images of the series “c” of frames g3(c1), g6(c2), g9(c3) and g12(c4) are sequentially captured by the operation in step ST41.

To play back the moving images captured as described above, operations similar to those of the first preferred embodiment shown in the flowchart of FIG. 9 are performed.

In the case where the series “a” is selected by the user, based on information of the image capturing condition tag TGp shown in FIG. 8, frame images g1(a1), g4(a2), g7(a3) and g10(a4) shown in FIG. 15 are extracted from all of the recorded frame images, and are sequentially played back and displayed on the LCD 16.

In the case where the series “b” is selected by the user, based on information of the image capturing condition tag TGp shown in FIG. 8, frame images g2(b1), g5(b2), g8(b3) and g11(b4) shown in FIG. 15 are extracted from all of the recorded frame images, and are sequentially played back and displayed on the LCD 16.

In the case where the series “c” is selected by the user, based on information of the image capturing condition tag TGp shown in FIG. 8, frame images g3(c1), g6(c2), g9(c3) and g12(c4) shown in FIG. 15 are extracted from all of the recorded frame images, and are sequentially played back and displayed on the LCD 16.

By the operation of the image capturing apparatus 1B, image capturing is performed while changing the exposure condition in three levels at a frame rate three times as high as the display frame rate. Consequently, three kinds of moving images can be easily captured by a single image capturing operation. Even if the user feels unsatisfactory regarding an exposure state which was determined proper before image capture, since other moving images of different exposure states were also captured, recording of a moving image satisfied by the user can be expected.

### Third Preferred Embodiment

An image capturing apparatus 1C according to a third preferred embodiment of the present invention has a configuration similar to that of the first preferred embodiment shown in FIGS. 1 to 3 except for the configuration of the control device.

In a control device 20C of the image capturing apparatus 1C, a control program for performing moving image capturing operation to be described below is stored in the ROM 201.

Moving Image Capturing Operation

In a manner similar to the image capturing apparatus 1A of the first preferred embodiment, the image capturing apparatus 1C can perform moving image capture at 90 fps shown in FIG. 4A and can capture moving images of three kinds of the series “a” to “c” by a single image capturing operation. In the image capturing apparatus 1C, the focus condition is not changed in three levels unlike the first preferred embodiment but a zoom condition (condition of focal length of the taking lens 11) is changed in three levels.

FIGS. 16A to 16C are diagrams illustrating three kinds of zoom states. In images shown in FIGS. 16A to 16C, a subject 0B is photographed.

An image shown in FIG. 16A is captured by setting the zoom slightly to the tele-side from a zoom value (focal length) set by the user.

An image shown in FIG. 16B is captured with the zoom value set by the user.

An image shown in FIG. 16C is captured by setting the zoom value slightly to the wide-side from the zoom value set by the user.

As described above, image capturing can be performed in three kinds of zoom states in the image capturing apparatus 1C. Therefore, the user can concentrate on an image capturing operation without minding the angle of view at the time of moving image capturing.

A concrete moving image capturing operation of capturing moving images of three kinds of zoom states will now be described.

FIG. 17 is a flowchart for describing the moving image capturing operation in the image capturing apparatus 1C. The operation is executed by the control device 20C. The user sets a desired zoom magnification by an operation unit while watching a preview screen of the LCD.

In steps ST51 to ST55, operations similar to those in steps ST1 to ST5 shown in the flowchart of FIG. 6 are performed.

In step ST56, the zoom is set to the tele-side from the zoom value designated by the user. Concretely, the zoom lens 111 is moved to the tele-side with respect to the focal length (reference parameter) of the taking lens 11 set by user's operation (predetermined process) on the operation button 171 before image capturing. At this time, the focus lens 112 is also driven so that the focus state of the subject does not change.

In step ST57, an image of the series “a” as shown in FIG. 16A is captured in the tele-side zoom state. The image captured by the image capturing device 21 is subjected to signal process in the signal processor 22, and the processed image is temporarily stored in the memory 23. After that, the image is subjected to imaging process in the image processing unit 24, and the processed image is recorded in the memory card 9.

In step ST58, the zoom value designated by the user is set. Concretely, the zoom lens 111 is moved to a position corresponding to the focal length designated before photographing. At this time, the focus lens 112 is also driven so that the focus state of the subject does not change.

In step ST59, an image of the series “b” as shown in FIG. 16B is captured in a zoom state designated by the user.

In step ST60, the zoom is set to the wide-side from the zoom value designated by the user. Concretely, the zoom lens 111 is moved to the wide-side with respect to the focal length which is set before image capturing. At this time, the focus lens 112 is also driven so that the focus state of the subject does not change.

In step ST61, an image of the series “c” as shown in FIG. 16C is captured in a wide-side zoom state.

In steps ST62 to ST64, operations similar to those in steps ST12 to ST14 shown in the flowchart of FIG. 6 are performed.

By the moving image capturing operation as described above, each frame image shown in FIG. 18 can be captured. Specifically, by the operation in step ST57, images of the series “a” of frames h1(a1), h4(a2), h7(a3) and h10(a4) are sequentially captured. By the operation in step ST59, images of the series “b” of frames h2(b1), h5(b2), h8(b3) and h11(b4) are sequentially captured. By the operation in step ST61, images of the series “c” h3(c1), h6(c2), h9(c3) and h12(c4) are sequentially captured.

The moving images captured as described above are played back by operations similar to those of the first preferred embodiment shown in the flowchart of FIG. 9.

Specifically, in the case where the series “a” is selected by the user, based on information of the image capturing condition tag TGp shown in FIG. 8, the frame images h1(a1), h4(a2), h7(a3) and h10(a4) shown in FIG. 18 are extracted from all of the recorded frame images, and are sequentially played back and displayed on the LCD 16.

In the case where the series “b” is selected by the user, based on information of the image capturing condition tag TGp shown in FIG. 8, the frame images h2(b1), h5(b2), h8(b3) and h11 (b4) shown in FIG. 18 are extracted from all of the recorded frame images, and are sequentially played back and displayed on the LCD 16.

In the case where the series “c” is selected by the user, based on information of the image capturing condition tag TGp shown in FIG. 8, the frame images h3(c1), h6(c2), h9(c3) and h12(c4) shown in FIG. 18 are extracted from all of the recorded frame images, and are sequentially played back and displayed on the LCD 16.

By the operation of the image capturing apparatus 1B, image capturing is performed while changing the zooming condition (the condition of the focal length of the taking lens 11) in three levels at a frame rate which is three times as high as the display frame rate. Consequently, three kinds of moving images can be easily captured by a single image capturing operation. Even when the user feels unsatisfactory regarding the zooming state which was determined proper before image capture, since other moving images of different zooming states are also captured, recording of a moving image satisfied by the user can be expected.

### Fourth Preferred Embodiment

An image capturing apparatus 1D according to a fourth preferred embodiment of the present invention has a configuration similar to that of the first preferred embodiment shown in FIGS. 1 to 3 except for the configuration of the control device.

Specifically, in a control device 20D of the image capturing apparatus 1D, a control program for performing moving image capturing operation which will be described below is stored in the ROM 201.

Moving Image Capturing Operation

The image capturing apparatus 1D can, like the image capturing apparatus 1A of the first preferred embodiment, perform the moving image capturing of 90 fps shown in FIG. 4A and capture three kinds of moving images of the series “a” to “c” by a single image capturing. In the image capturing apparatus 1D, the focus condition is not changed in three levels unlike the first preferred embodiment but the white balance (WB) condition is changed in three levels.

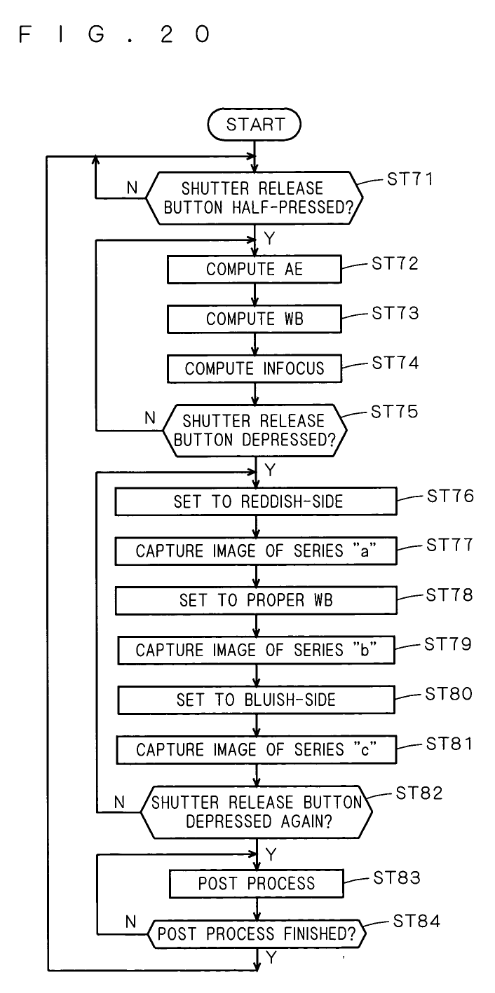

FIGS. 19A to 19C are diagrams illustrating three kinds of WB states. Images shown in FIGS. 19A to 19C are of sunset scenes.

The image shown in FIG. 19A is captured by performing the WB computation by the WB computing unit 27 and, after that, setting the WB control value to the reddish-side from a proper WB control value. In this case, since the WB control value is set to the reddish-side, an image of a clear sunset scene can be captured.

The image shown in FIG. 19B is captured by performing the WB computation by the WB computing unit 27 and, after that, setting the WB control value to the proper WB control value (reference parameter). In this case, although image capturing is performed with the proper value based on the WB computation, an image of a sunset scene whish is not so satisfactory is captured.

The image shown in FIG. 19C is captured by performing the WB computation by the WB computing unit 27 and, after that, setting the WB control value to the bluish-side from the proper WB control value. In this case, since the WB control value is set to the bluish-side, an image which is not so satisfactory as an image of a sunset scene is captured.

As described above, the image capturing apparatus 1D can perform image capturing in three kinds of WB states. Consequently, the user can concentrate on an image capturing operation without minding whether an intended white balance state is obtained or not at the time of capturing a moving image.

A concrete moving image capturing operation for obtaining moving images in three kinds of WB states will be described below.

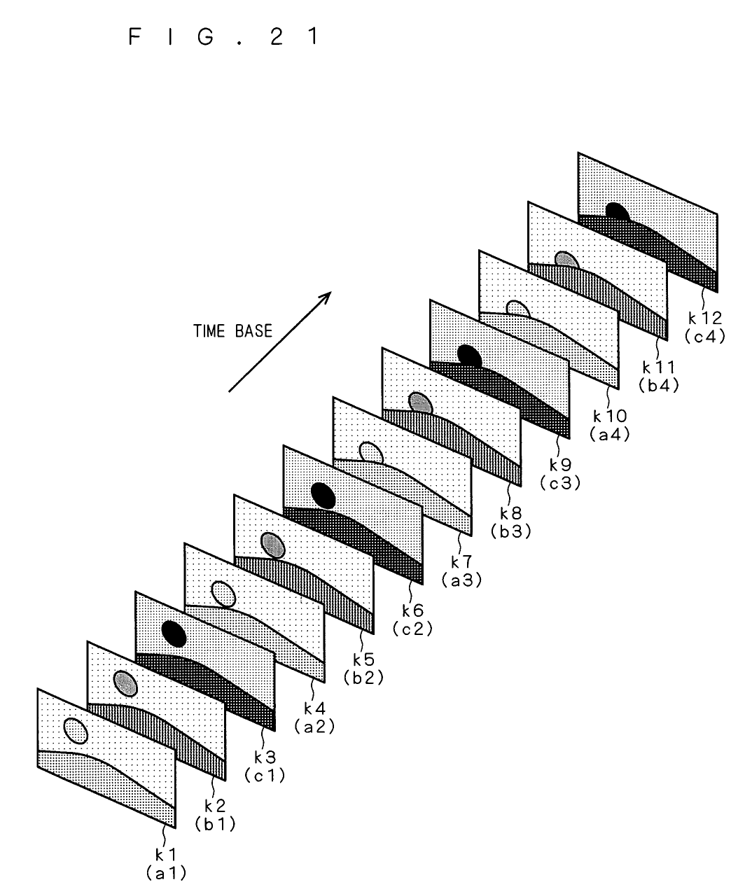

FIG. 20 is a flowchart for describing the moving image capturing operation in the image capturing apparatus 1D. The operation is executed by the control device 20D.

In steps ST71 to ST75, operations similar to those in steps ST1 to ST5 shown in the flowchart of FIG. 6 are performed.

In step ST76, the white balance is set to the reddish side. Concretely, the R gain among the R and B gains determined in step ST73 is increased.

In step ST77, an image in the series “a” as shown in FIG. 19A is captured in the reddish WB state. The image captured by the image capturing device 21 is subjected to the signal process in the signal processor 22 and the processed image is temporarily stored in the memory 23. After that, the image is subjected to the imaging process in the image processor 24 and the processed image is recorded in the memory card 9.

In step ST78, the white balance is set to a proper value. Concretely, the R and G gains determined in step ST73 are set.

In step ST79, an image in the series “b” as shown in FIG. 19B is captured in the proper WB state.

In step ST80, the white balance is set to the bluish-side. Concretely, the B gain among the R and B gains determined in step ST73 is increased.

In step ST81, an image in the series “c” as shown in FIG. 19C is captured in the bluish WB state.

In steps ST82 to ST84, operations similar to those in steps ST12 to ST14 shown in the flowchart of FIG. 6 are performed.

By the moving image capturing operation as described above, each frame image shown in FIG. 21 can be captured. Specifically, by the operation in step ST77, images of the series “a” of frames k1(a1), k4(a2), k7(a3) and k10(a4) are sequentially captured. By the operation in step ST79, images of the series “b” of frames k2(b1), k5(b2), k8(b3) and k11(b4) are sequentially captured. By the operation in step ST81, images of the series “c” of frames k3(c1), k6(c2), k9(c3) and k12(c4) are sequentially captured.

The moving images captured as described above are played back by operations similar to those of the first preferred embodiment shown in the flowchart of FIG. 9.

Specifically, in the case where the series “a” is selected by the user, based on information of an image capturing condition tag TGp shown in FIG. 8, frame images k1(a1), k4(a2), k7(a3) and k10(a4) shown in FIG. 21 are extracted from all of the recorded frame images, and sequentially played back and displayed on the LCD 16.

In the case where the series “b” is selected by the user, based on information of the image capturing condition tag TGp shown in FIG. 8, frame images k2(b1), k5(b2), k8(b3) and k11(b4) shown in FIG. 21 are extracted from all of the recorded frame images, and are sequentially played back and displayed on the LCD 16.

In the case where the series “c” is selected by the user, based on information of the image capturing condition tag TGp shown in FIG. 8, frame images k3(c1), k6(c2), k9(c3) and k12(c4) shown in FIG. 21 are extracted from all of the recorded frame images, and are sequentially played back and displayed on the LCD 16.

By the operation of the image capturing apparatus 1D, image capturing is performed while changing the WB condition in three levels at a frame rate three times as high as the display frame rate. Consequently, three kinds of moving images can be easily captured by a single image capturing operation. Even if the user feels unsatisfactory regarding the WB state which was determined proper before image capture, since other moving images of different WB states are also captured, recording of a moving image satisfied by the user can be expected.

Modifications

In the first preferred embodiment, it is not indispensable to change the focus position with respect to a main subject in order of the main subject side, proper value and the camera side. For example, it is also possible to change the condition so as to move the focus lens around the infocus position as a center like the subject side, proper value, camera side, proper value, subject side, . . . . That is, the focus condition is changed so as to be varied to control parameters in opposite directions as amplitudes around the reference parameter corresponding to the infocus on the main subject as a center. By changing the focus condition in such a manner, the lens can be smoothly driven and the lens driving amount can be reduced.

Also in the second and third preferred embodiments, the exposure condition and the focal length condition may be changed in a manner similar to the focus condition.

In the foregoing preferred embodiments, it is not necessary to capture a moving image at a frame rate (90 fps) which is three times as high as the display frame rate (30 fps) used at the time of displaying a moving image. Alternatively, a moving image can be also captured at a frame rate which is twice or four or more times as high as the display frame rate, that is, a frame rate of N times (N: integer of 2 or more). When image capturing is performed with main conditions, image capturing wider than the proper property can be performed. Thus, the possibility that the user obtains a satisfactory moving image increases.

The image capturing condition such as the focus condition does not have to be changed in three levels. For example, it may be changed in two levels. The multiple of the frame rate and that of the image capturing conditions do not have to coincide with each other. Image capturing may be performed while changing the image capturing condition based on a pattern of changing the image capturing condition in M stages (M: integer satisfying the relation of 2≦M≦N).

A moving image may be also captured while changing the image capturing condition at the same frame rate (30 fps) as the frame rate at which a moving image is displayed. In this case, when the image capturing condition is changed, for example, in three levels and moving image capturing is performed, at the time of playing back the moving images in the series “a” to “c”, the frame rate becomes 10 fps and smooth motion is sacrificed. However, the size of a moving image file can be reduced and, even in the case where the processing ability of the camera is low, image capturing can be performed.

In the foregoing preferred embodiments, it is not essential to change one of the image capturing conditions of the focus condition, exposure condition, focal length condition of the image capturing optical system, and white balance condition. The present invention is not limited to the preferred embodiments but a combination of a plurality of conditions among the four kinds of image capturing conditions may be changed. In this way, the possibility that the user obtains a satisfactory moving image increases.

In the foregoing preferred embodiments, it is not essential to use a CMOS as the image capturing device. Alternatively, a CCD may be used.

In the foregoing preferred embodiments, it is not essential to play back an image by the image capturing apparatus (camera). For example, a moving image file recorded in the memory card 9 may be played back by a personal computer or the like.

With respect to the moving image format of the foregoing preferred embodiments, it is not essential to use the motion JPEG method but the MPEG format may be used.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus with a display device which can display an image, comprising:
(a) an image capturing device which sequentially generates frame images of a subject;
(b) a driver which drives said image capturing device at a frame rate that is N times (N: integer of 2 or more) as high as a display frame rate used at the time of displaying a moving image on said display device; and
(c) a controller which sequentially captures said frame images at said frame rate of N times while changing an image capturing condition in M levels (M: integer satisfying a relation of 2≦M≦N) each time said image capturing device is driven by said driver.

2. The image capturing apparatus according to claim 1, wherein said controller includes:
(c-1) a giving controller which gives identification information for identifying each of levels of said image capturing condition to said frame images.

3. The image capturing apparatus according to claim 2, wherein said controller includes:
(c-2) a recording controller which sequentially records said frame images to which said identification information is given to a recording medium by said giving controller; and
(c-3) a playback controller which extracts frame images having said same identification information from a plurality of frame images recorded on said recording medium and sequentially displays extracted frame images at said display frame rate on said display device.

4. The image capturing apparatus according to claim 1, wherein
said image capturing condition includes at least one condition selected from a group of conditions consisting of a focus state, exposure, focal length of an image capturing optical system, and white balance.

5. The image capturing apparatus according to claim 1, wherein
M image capturing control parameters corresponding to said image capturing conditions in M levels include a reference parameter which is set by a predetermined process and parameters obtained by shifting said reference parameter as a center in opposite directions.

6. The image capturing apparatus according to claim 5, wherein
said controller changes said image capturing condition so as to be shifted from said reference parameter as a center in opposite directions as amplitudes.

7. An image capturing apparatus comprising:
(a) an image capturing device which sequentially generates frame images of a subject;
(b) a driver which drives said image capturing device at a predetermined frame rate; and
(c) a controller which sequentially captures said frame images at said predetermined frame rate while changing an image capturing condition in M levels (M:
integer satisfying a relation of 2≦M≦N) each time said image capturing device is driven by said driver.

8. The image capturing apparatus according to claim 7, wherein
said predetermined frame rate is a frame rate used at the time of displaying a moving image.

9. The image capturing apparatus according to claim 7, wherein
said controller includes:
(c-1) a giving controller which gives identification information for identifying each of levels of said image capturing condition to said frame image.

10. The image capturing apparatus according to claim 9, wherein
said controller includes:
(c-2) a recording controller which sequentially records said frame images to which said identification information is given to a recording medium by said giving controller; and
(c-3) a playback controller which extracts frame images having said same identification information from a plurality of frame images recorded on said recording medium and sequentially displays extracted frame images on said display device.

11. The image capturing apparatus according to claim 7, wherein
said image capturing condition includes at least one condition selected from a group of conditions consisting of a focus state, exposure, focal length of an image capturing optical system, and white balance.

12. The image capturing apparatus according to claim 7, wherein
M image capturing control parameters corresponding to said image capturing conditions in M levels include a reference parameter which is set by a predetermined process and parameters obtained by shifting said reference parameter as a center in opposite directions.

13. The image capturing apparatus according to claim 12, wherein
said controller changes said image capturing condition so as to be shifted from said reference parameter as a center in opposite directions as amplitudes.

14. An image playback apparatus for playing back image data, comprising:
an extracting part which extracts images captured with the same image capturing condition on the basis of a sign given to images, said sign being given to each of said images captured while setting N kinds (N: integer of 2 or more) of image capturing conditions so as to identify an image capturing condition used among said N kinds of image capturing conditions at the time of driving an image capturing device at a frame rate which is N times as high as a frame rate for display; and
a display instruction part which gives an instruction of continuous display relating to said images extracted by said extracting part.
